(19) United States
(12) Patent Application Publication
(10) Pub. No.: US 2007/0107052 A1
(43) Pub. Date: May 10, 2007

(54) Method and apparatus for monitoring operation of processing systems, related network and computer program product therefor

(76) Inventors: Gianluca Cangini, Torino (IT); Gerardo Lamastra, Torino (IT); Francesco Coda Zabetta, Torino (IT); Paolo Abeni, Torino (IT); Madalina Baltatu, Torino (IT); Rosalia D'Alessandro, Torino (IT); Stefano Brusotti, Torino (IT); Sebastiano Di Paola, Torino (IT); Manuel Leone, Torino (IT); Federico Frosali, Torino (IT)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 10/582,848

(22) PCT Filed: Dec. 17, 2003
(86) PCT No.: PCT/EP03/14385

§ 371 Date: Jun. 14, 2006

(51) Int. Cl. G06F 12/14

(52) U.S. Cl. 726/22

(57) ABSTRACT

Apparatus for monitoring operation of a processing system includes a set of modules for monitoring operation of a set of system primitives that allocate or release the system resources and are used by different processes running on the system. Preferably, the modules include at least one application knowledge module tracking the processes running on the system and monitoring the resources used thereby, a network knowledge module monitoring connections by the processes running on the system, a file-system analysis module monitoring the file-related operations performed within the system, and a device monitoring module monitoring operation of commonly used modules with the system. A preferred field of application is in host-based intrusion detection systems.

### FIELD OF THE INVENTION

This invention relates to techniques for monitoring (e.g. analyzing) operation of processing systems such as computer systems and networks.

The invention was developed by paying specific attention to the possible application to computer intrusion detection systems, i.e. systems that detect security problems in computer systems and networks caused by the malevolent action of an external or internal agent. The agent can be an automatic system (i.e. a computer virus or a worm) or a human intruder who tries to exploit some weaknesses in the system for a specific purpose (i.e. unauthorized access to reserved data).

### DESCRIPTION OF THE RELATED ART

The purpose of a computer intrusion detection system (IDS) is to collect and analyze information on the activity performed on a given computer system in order to detect, as early as possible, the evidence of a malicious behavior.

Two fundamental mechanisms have been developed so far in the context of intrusion detection, namely: network-based intrusion detection systems (i.e. so-called NIDS) and host-based intrusion detection systems (HIDS).

NIDS analyze packet flow in the network under surveillance, searching for anomalous activities; the vast majority of NIDS employs pattern-based techniques to discover evidence of an attack. Conversely, HIDS operate on a per-host basis, using a wider variety of techniques, to accomplish their purpose.

HIDS are usually better tailored for detecting attacks likely to really impact on the host under their control.

NIDS systems have a broader vision over the computer network than their host-based counterpart; so they can correlate different attacks more easily and can detect anomalies that can be neglected if only a single host is taken into account. However some specific attacks that involve ciphered connections or some form of covert channels, are extremely harder to discover using only network based techniques. As a consequence, both approaches must be preferably be used in a truly complete and effective intrusion detection system.

Two fundamental figures are currently evaluated in order to measure the effectiveness of an intrusion detection system: the rate of false-positives and the rate of false-negatives. False-positives designate those normal situations that are erroneously detected as attacks, false-negatives are effective attacks which are not correctly identified by the IDS.

The primary goal of an IDS is to minimize these figures, while maintaining an acceptable analysis rate (that is, the number of events that can be analyzed in the time unit).

Obviously, different technologies result in different false-positive and false-negative rates. The most common techniques employed in intrusion detection systems are misuse detection and anomaly detection. Artificial intelligence and state analysis techniques have been used occasionally in few implementations.

Misuse detection is the technique commonly adopted in NIDS. Usually, some sort of pattern matching algorithm is applied over a series of rules to detect misuse conditions. This approach is discussed, for example, in “A Pattern Matching Model for Misuse Intrusion Detection” by S. Kumar, E. Spafford and al. in the Proceedings of the 17^{th} National Computer Security Conference. Also, several patents have issued in connection with pattern-based IDS systems, U.S. Pat. No. 5,278,901 and U.S. Pat. No. 6,487,666 being cases in point.

Specifically, U.S. Pat. No. 5,278,901 discloses an intrusion detection technique based on state analysis. The prior art document in question describes several independent intrusion patterns using the graph formalism, and provides a mechanism that, starting from the audit trail generated by the host operating system, is able to detect whether a sequence of operations on the system can be mapped onto one of the graphs representing the intrusion scenarios. The complexity involved in defining the patterns that model an intrusion, makes this approach unsuitable for use in anomaly-based intrusion detection systems.

More generally, pattern-based systems are well suited for NIDS but are not very efficient in the context of HIDS as they can generate high false-negative rates: in fact HIDS fail to detect something for which a specific signature has not been provided.

Anomaly detection has also been widely used for both network-based and host-based intrusion detection systems (especially with HIDS). When such an approach is resorted to, the IDS is trained (using a pre-defined policy or some form of automatic learning) on the normal system behavior, and detects any deviation from this standard configuration. Clearly, this approach is able to cope with unseen attack patterns, reducing the false-negative rate. However, it also shows a markedly higher false-positive rate, because some permitted actions have not been included in the policy or have not been observed during the learning stage. For a detailed discussion of the application of anomaly detection in the field of intrusion detection, reference can be made to D. Wagner and D. Dean: “Intrusion Detection Via Static Analysis”, IEEE Symposium on Security and Privacy, 2001.

One of the most interesting applications of anomaly detection in the context of host-based IDS is the analysis of the sequences of system calls, or system primitives, issued during the normal process activity. Generally speaking, a modern operating system uses at least two different levels of privilege for running applications: at the user level, the application behavior is constrained and the single application cannot manipulate arbitrarily system wide resources, while at the kernel level, the application has a complete control over the system. The transition between the user and the kernel levels is regulated by the system calls, also known as “syscalls” or system primitives, which allow an non-trusted application to manipulate a system-wide resource. For example, using a system call an application can spawn (or terminate) another application, create a file, or establish a network connection.

The possibility of monitoring effectively the behavior of a given application is broadly accepted; for example, S. Forrest and al. in “A Sense of Self for Unix Processes” published in the 1996 IEEE Symposium on Security and Privacy, discuss a method for anomaly detection based on the short-range correlation of sequences of system calls.

In EP-A-0 985 995, an advanced application of this technique is disclosed which relies on the TEIRESIAS algorithm. The arrangement of EP-A-0 985 995 uses system call analysis to derive a complete characterization for a given application; this means that for the specific process executing an instance of the application, the entire sequence of system calls is collected and organized in sequence of repeated-patterns; at detection time, a sequence of system call is then compared with the list of pattern to identify an anomaly in the application.

In US patent application US-2002/0138755 another intrusion detection technique is discussed based on anomaly detection. The disclosure focuses on a method that allows modeling the behavior of a single process using a set of logical formulas, known as Horn Clauses. These formulas are derived from both acceptable and dangerous sequences of system calls, which are used to describe some exemplary behavior, although the algorithm can produce a working model using only acceptable sequences.

System call analysis is not only suitable for anomaly detection approaches, but it can be used also in a more classical misuse detection scheme.

For instance U.S. patent applications US-2002/0083343 and US-2002/0046275 disclose an intrusion detection system architecture that exploits, among other sources of data, system call events to detect sequences that can possibly indicate an intrusion. The architecture described in these prior art documents is fairly complex and it is based on various modules and layers to build a comprehensive IDS system.

State analysis techniques are another emerging area of research in the field of intrusion detection.

These techniques have been the main focus of the so-called “STAT” project, which is discussed in various papers such as K. Ilgun, R. A. Kemmerer, and P. A. Porras, “State Transition Analysis: A Rule-Based Intrusion Detection Approach”, IEEE Transaction on Software Engineering and G. Vigna, S. T. Eckmann and R. A. Kemmerer “The STAT Tool Suite”, Proceedings of DISCEX 2000. The STAT framework is fairly generic, and defines a language to express and represent the attack scenarios for different kinds of context (i.e. both in the NIDS and HIDS contexts). Specifically, some specific attack scenarios are defined that have to be matched on the system model for the attack to be detected (therefore the system performs a misuse detection). Moreover these attack scenarios have to be explicitly coded in some computer-based language.

### OBJECT AND SUMMARY OF THE INVENTION

The basic object of the present invention is thus to provide an improved arrangement that dispenses with with the intrinsic drawbacks of the prior art extensively considered in the foregoing. Specifically, the present invention aims at:
dispensing with the disadvantages of those arrangements based on misuse detection that are exposed to the risk of generating a high number of “false negatives” if the rules that dictate operation of the system are not continuously and timely updated, and
providing, in the case of arrangements based on anomaly detection, system-wide operation, without limitations to any specific application and making it possible for the arrangement to become an expert system adapted to learn proper intervention policies.

According to the present invention, that object is achieved by means of a method having the features set forth in the claims that follow. The invention also relates to a corresponding apparatus, a related network as well as a related computer program product, loadable in the memory of at least one computer and including software code portions for performing the steps of the method of the invention when the product is run on a computer. As used herein, reference to such a computer program product is intended to be equivalent to reference to a computer-readable medium containing instructions for controlling a computer system to coordinate the performance of the method of the invention. Also, reference to at least one computer is intended to highlight the possibility for the invention to be implemented in a de-centralized fashion.

A preferred embodiment of the invention is thus an anomaly based monitoring system which exploits a mixture of the state analysis technique, “syscall” (system primitives) sequence analysis and rule-based reasoning. Specifically, such a preferred embodiment provides for monitoring operation of a processing system including a set of system resources and having a plurality of processes running thereon by monitoring operation of a set of primitives. The set of primitives monitored is selected as a set comprised of system primitives that i) allocate or release said system resources, and ii) are used by different processes in said plurality.

Such a preferred embodiment of the invention is based on the recognition that a processing system including a set of system resources can be effectively monitored, e.g. for intrusion detection purposes, by achieving system-wide operation by monitoring a set primitives used by different processes (and not just by a single application). The related processing load may be maintained within reasonable limits by selecting the primitives in question as system primitives that allocate (i.e. request) or release one of the system resources.

Preferably, the set of primitives monitored includes all the system primitives that allocate or release said system resources or includes exclusively those system primitives that allocate or release said system resources.

A preferred embodiment of the arrangement of the invention is a system comprising three high-level logical components, namely:
a system-wide information gathering component, which intercepts low-level data from the host system, and allows watching every change in the state of the system, while providing data to be analyzed for monitoring purposes, e.g. in order to detect intrusions; low-level data comprises system calls, or system primitives, with their call and return parameters, and information relative to system resources in use (e.g. file, socket, device . . . );
a detection component, which represents the core of the monitoring system, carries out the data analysis. It performs anomaly detection by revealing differences between the current state of the system and the state recorded during a previous period of time when the system is assumed to be safe. These anomalies consist in suspicious events that could represent an intrusion, so they can cause the emission of an alert to a management system; and
a management system, which shows all the alerts, collects them for off-line analysis and possibly generates graphical reports. Moreover, it allows the administrator to tune and configure the whole system.

The detection component preferably includes three logical sub-components with specific goals. The first sub-component maintains a real-time high-level model of the current state of the monitored host. The second sub-component is comprised of different modules that use that high-level model to perform the anomaly detection, each of them having a specific view of the whole system, such as network activity or file system status. The third sub-component receives and correlates the anomalies to decide if they can represent an intrusion and, in this case, issues an alert to the management system.

The basic idea of the arrangement described herein is to build a synthetic, comprehensive representation of the system; this model has to be initialized correctly, in order to reflect the current state of the system when the intrusion detection system is started. After initialization, each security-related event generated in the real system is forwarded to the model, which is updated accordingly. Usually such events come in the form of well-defined system calls. A specific component of the intrusion detection system (running in kernel space) selects the system calls that need to be analyzed and forwards them to the user space component.

In that way, even if decoupled, the model and the real system remain perfectly synchronized.

An intrusion detection system may thus perform specific analysis on the system model, tracking various kinds of anomalies. The system is built using a modular approach, so it is possible to extend and tailor the configuration according to the characteristics of the host under surveillance.

Preferably, several different analysis modules (called “knowledge bases”) are implemented. An application knowledge base tracks the processes that run on the system, monitoring the resource they use and their current state. A file-system knowledge base controls all the file related operations, such as creation and deletion of files, and so on. A network knowledge base analyzes all the incoming and outgoing connection, searching for anomalous activities.

Each knowledge base can operate in two essential modes; in the learning mode, it updates itself accordingly to the events occurring in the system; in the analysis mode, it compares the current state of the system with the state observed during the learning stage. The main purpose of knowledge bases is to emulate the way in which a human system administrator detect that something wrong is happening on the system. More precisely, the knowledge bases provide an analog model of a system sub-component which is close to the model that a human system administrator keeps in mind when searching the system for anomalies.

Whenever a knowledge base detects an anomalous behavior, a signal (hereinafter defined “led alert”) is raised; each led alert is assigned a specific weight, defined by the knowledge base itself. The weight gives an indication about the criticality of the event. For example, the weight assigned to the execution of a completely new application is higher than the weight assigned to the execution of an extra instance of an already known application that has never been launched twice simultaneously by the same user.

All the led alerts are collected by an alerter module, which uses a rule based mechanism to correlate and aggregate this information. For example, if a new application is activated, a new file is created from this specific application and a new network connection is activated; all these events generate led alerts that are aggregated in a single user-level alert that pinpoints what is happening on the target host. Moreover, a damping mechanism is used to avoid that an overwhelming number of signals may produce a long sequence of identical alerts.

The alerter module employs different algorithms to process and analyze alerts. Some specific sequence of action can be easily mapped onto “bad behaviors”; for other scenarios, it is possible to detect some general anomalies that the operator needs to further track down.

A further element in the preferred system architecture described herein is a management system. This is used to produce alerts in a human readable form and archive them for forensic purposes or trend analysis.

The arrangement described herein thus uses an anomaly detection scheme based on the analysis of the system call events generated by the entire system, that is those system primitives that either allocate or release one of the system resources.

The stream of events thus monitored is used to build a synthetic representation of the system; the analysis is then conducted on this optimized representation, using specific modules, which address well defined areas of the system. For example, a process analysis module is used to examine all the application running on the system, monitoring some specific actions; a file-system module is used to analyze the operations at the file level. Whenever a module detects something that has never been observed in the past, it generates a signal. All the signals are collected by a correlation engine that, using a specific rule-base, decides whether to emit a console alert or not.

To sum up, a preferred embodiment of the invention uses a combination of system call analysis, state-based analysis and rule-based reasoning to detect attacks on the controlled host. The selection of the specific system calls to be used for that purpose and the way data are collected play a significant role in such an arrangement. Another significant feature is the organization of the various knowledge bases; each knowledge base defines a specific way to look at the system, just like a human administrator would do. The knowledge base captures the set of tests and analyses that a skilled administrator performs on the system to detect the early signs of an anomaly. The anomaly detection paradigm is thus used to “learn” what is considered to be the normal system behavior; the system state is then built from the learning stage and the intrusion detection is performed by searching for relevant anomalies from the regular system state.

It will be appreciated that a major difference between the arrangement discussed in EP-A-0 985 995 and a preferred embodiment of the present invention is the use of formal logic to model the system behavior compared to the analog models used in a preferred embodiment of the current invention. The analog models mimic the effective system component under analysis, providing a simplified view on it, which is essentially similar to the reference picture used by the administrator to track down any system anomaly. This model is somewhat “fuzzier” than the one used in the prior art, but is able to capture a broader view on the system under analysis.

The arrangement described herein is thus adapted to provide improved operation and results, while dispensing with the disadvantages of those arrangements based on misuse detection that are exposed to the risk of generating a high number of “false negatives” if the rules that dictate operation of the system are not continuously and timely updated.

Additionally, the arrangement described herein provides system-wide operation based on anomaly detection, without limitations to any specific application and making it possible for the arrangement to become an expert system adapted to learn proper intervention policies.

### BRIEF DESCRIPTION OF THE ANNEXED DRAWINGS

The invention will now be described, by way of example only, by referring to the enclosed figures of drawing, wherein:

FIG. 1 is a block schematic representation of an analysis system as described herein,

FIG. 2 to 7 are functional representations of various parts of the system of FIG. 1, and

FIG. 8 is an exemplary representation of possible operation of the system described herein.

### DETAILED DESCRIPTION OF PREFERRED EMBODIMENTS OF THE INVENTION

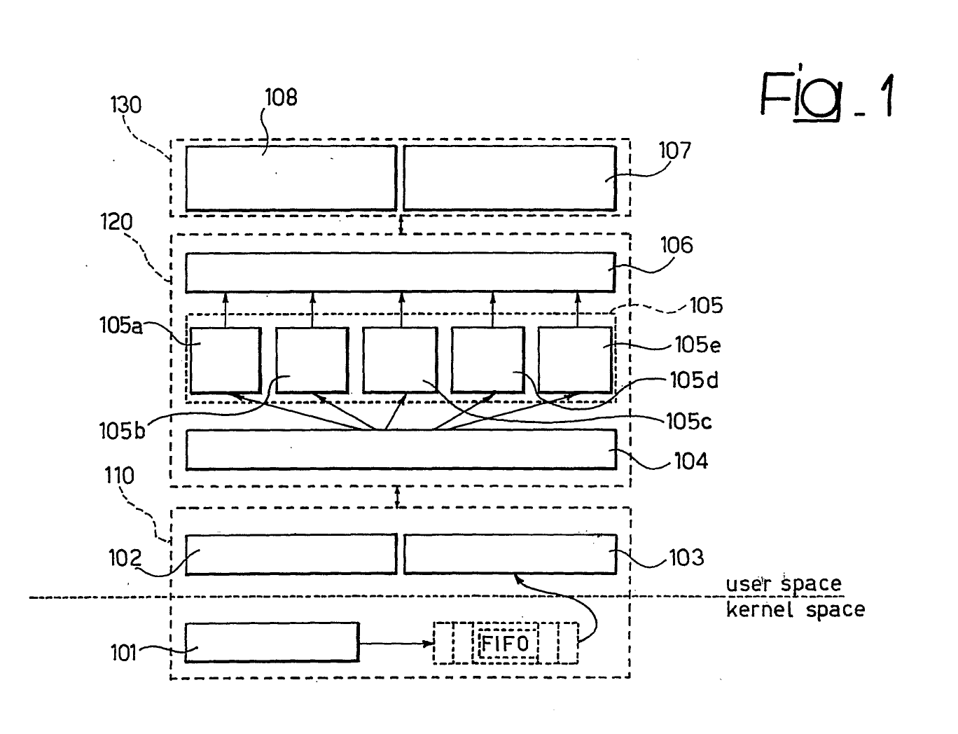

A possible embodiment of the arrangement described herein is portrayed in FIG. 1 in the form of a host-based intrusion detection system (HIDS) comprised of three high-level logical components, namely:
a system-wide information gathering component 110 which intercepts low-level data from a host computer (not shown), thus being arranged “straddling” a kernel space and the user space proper; low-level data comprises system calls, or system primitives, with their call and return parameters, and, information relative to system resources in use (e.g. file, socket, device . . . );
a detection component 120 which performs data analysis in order to reveal possible intrusions, thus representing the core of the HIDS; and
a management system 130 which shows so-called alerts to be described in greater detail in the following, logs them for off-line analysis, generates reports, and allows the administration and configuration of the whole system.

The detection component 120 can be in turn divided into three logical sub-components with specific goals:
a first sub-component 104 is a current state module that maintains a real-time high-level model of the current state of the monitored host;
a second sub-component 105 (in turn comprised of a plurality of modules 105a, 105b, 105c, 105d, and 105e to be described later), using a high-level model, learns the “good” behavior of the system by recording all possible states reached in a “regular” period of work; then it performs anomaly detection by revealing differences between the instantaneous state and the recorded ones;
a third sub-component 106 is an alerter module that receives and correlates the anomalies to decide if they can represent an intrusion and, in this case, emits an alert to the management system 130.

In the currently preferred embodiment of the arrangement described herein, the three components are realized by several modules that interact sequentially.

A device driver 101 in the component 110 intercepts system primitives (briefly defined “syscalls” or “system calls” in the following) in kernel space and provides them to a syscall processor 103.

A kernel information module 102 reads all the required information about the processes running, allowing the other modules to build an instantaneous snapshot of the system state. This information is used in the current state module 104 for initialization and, when needed, for maintaining synchronization with the system.

The syscall processor 103 translates syscalls into higher level, OS independent, abstractions and forwards them to the current state module 104.

The current state module 104 is initialized with the information taken from the kernel info module 102. Subsequently it uses the system call sequence stream, as provided by the syscall processor 103, to remain synchronized with the host system. If a mismatch is detected, the current state module 104 is able to scan the real system again (through the interface provided by the kernel info module 102). After updating the internal state, the syscall event or the re-synchronization event is forwarded to a set of knowledge base modules 105 provided in the system.

The knowledge base (KB) modules 105a′, 105b, 105c, 105d, and 105e (collectively designated 105) use the syscall and the resynchronization events in two different conditions; during the learning mode, each event updates the internal database and enhances the knowledge on the system behavior; in the analysis mode, the event is matched against the database and, if an anomaly is detected, a so-called led alert is sent to an Alerter module 106.

A led alert is essentially a collection of uniform data that indicates the cause of the anomaly, where and when it was generated.

The alerter 106 receives led alerts from all the knowledge base modules 105, and correlates them in order to obtain significant information about the possible intrusions. The resulting alerts are then sent to the management system 130.

In the presently preferred embodiment, the alerter module 106 is comprised of a basic correlation module/mechanism (discussed in detail in the following) and a fuzzy-logic inference engine configured to aggregate independent alerts, so as to suggest what kind of anomaly has been effectively detected by the underlying sensors.

The management system 130 consists of two logical parts. One part, designated 107, displays e.g. on a graphic console the alerts coming from the HIDS, shows the current state of the monitored hosts and can save all the alerts onto a local database to provide off-line analysis, such as trend and forensic analysis. The other part, designated 108, provides all the functions to monitor and to configure the work of every single part of the HIDS.

Three components (i.e. the kernel info module 102, the device driver 101, and the syscall processor 103)—among the various elements shown—are system dependent, and have to be implemented for every different operating system; the other elements described are system-independent and are based on a logical abstraction of data taken form the underlying system.

The device driver 101 is a system-dependent component which intercepts a subset of all possible system calls along with their return value and invocation parameters.

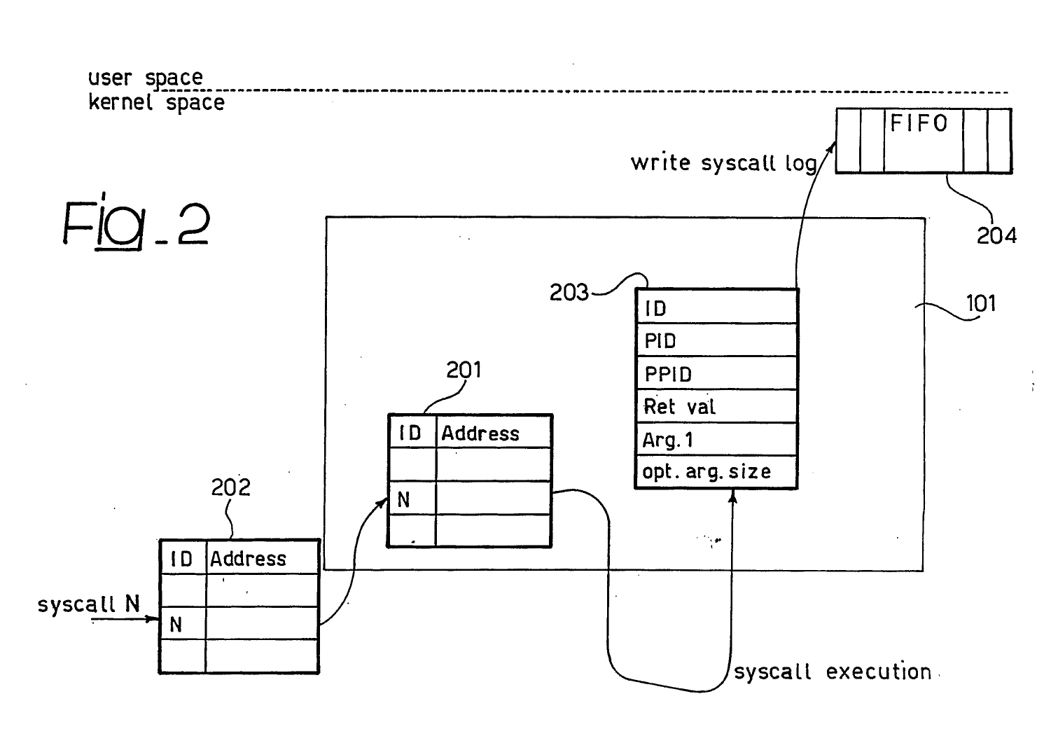

As shown in FIG. 2, the device driver 101 runs in kernel space and, upon activation, saves the structure containing the addresses of the sub-routines corresponding to each system call 201 (i.e. in UNIX-like systems, the array syscall_table[syscall ID]) and substitutes it with its own sub-routines 202. Each of these sub-routines runs the savedsub-routine, acting sa a wrapper. In case of success, logs the syscall data 203 on a FIFO device 204. Data is produced as a byte stream of system-dependent information, which will be read and translated into a higher level—system independent—abstraction by the syscall processor 103.

By way of example, in an embodiment for a UNIX-type system, the subset of system calls with related parameters and abstraction translation is as shown in Table 1 below.

TABLE 1

| | Common | Return | | |
|---|---|---|---|---|
| ID | Name | Value | Parameters | Translation |
| 1 | EXIT | | | processExit( ) |
| 2 | FORK | new PID | | processFork( ) |
| 5 | OPEN | new file | file name | processOpen( ) |
| | | descriptor | opening mode | |
| | | | file name | |
| | | | length | |
| 6 | CLOSE | | file | processClose( ) |
| | | | descriptor | |
| 8 | GREAT | new file | file name | processOpen( ) |
| | | descriptor | opening mode | |
| | | | file name | |
| | | | length | |
| 11 | EXECVE | | process name | processExec( ) |
| | | | process | |
| | | | arguments | |
| 23 | SETUID | | new UID | processSetuid( ) |
| 41 | DUP | | old file | processDup( ) |
| | | | descriptor | |
| | | | new file | |
| | | | descriptor | |
| 42 | PIPE | new file | | processOpen( ) |
| | | descriptor | | processOpen( ) |
| 63 | DUP2 | | old file | processDup( ) |
| | | | descriptor | |
| | | | new file | |
| | | | descriptor | |
| 70 | SETREUID | | new UID | processSetuid( ) |
| 120 | CLONE | new PID | | processFork( ) |
| 164 | SETRESUID | | new UID | processSetuid( ) |
| 190 | VFORK | new PID | | processFork( ) |
| 203 | SETREUID32 | | new UID | processSetuid( ) |
| 208 | SETRESUID32 | | new UID | processSetuid( ) |
| 213 | SETUID32 | | new UID | processSetuid( ) |
| 251 | SOCKET | new socket | socket data | processSocket( ) |
| | | descriptor | (domain, | |
| | | | port, protocol) | |
| 252 | BIND | | socket | processBind( ) |
| | | | descriptor | |
| | | | (port) | |
| 253 | CONNECT | | socket | processConnect( ) |
| | | | descriptor | |
| 254 | LISTEN | | socket | processListen( ) |
| | | | descriptor | |
| 255 | ACCEPT | new socket | socket data | processAccept( ) |
| | | descriptor | (domain, | |
| | | | port, protocol) | |
| | | | old socket | |
| | | | descriptor | |
| 258 | SOCKETPAIR | new socket | socket data | processSocket( ) |
| | | descriptor | (domain, | processSocket( ) |
| | | pair | port, protocol) | |

It will be appreciated that the system calls listed in the foregoing comprise a set grouping all the system primitives that either allocate (i.e. request) or release one of the system resources.

The device driver 101 does not provide syscall logging for the process that uses it; if this happened, an unstable loop would occur: in fact, for each syscall logged, the user-space layer would execute a read( ) operation, that would cause another event to be posted in the FIFO; this sequence of events would eventually lead to resource exhaustion for the Device Driver, and the system would stop working.

The kernel info module 102 is another system-dependent component which is able to read information for all processes running on the monitored system. It saves their status in internal variables and exposes public methods for accessing this information.

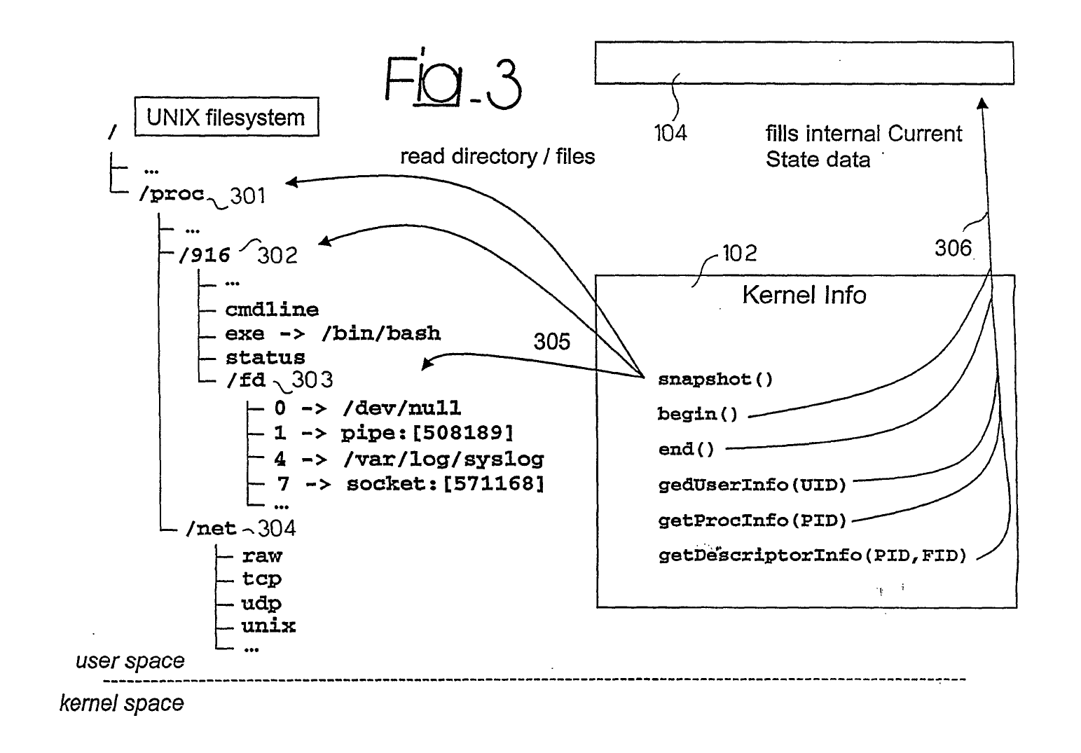

In an exemplary embodiment for a UNIX-type system, as shown in FIG. 3, all the information needed is available from a /proc directory 301. The /proc directory contains a sub-directory entry for every running process; the sub-directory is named after the current PID of the process: for example, a process with PID number 916, the corresponding sub-directory is /proc/916, designated 302 in FIG. 3.

The subdirectory contains a set of text files and links (in particular cmdline, exe, status) providing detailed information about the process, such as PID (Process IDentifier), PPID (Parent Process IDentifier), EUID (Effective User IDentifier), executable pathname, command line of invocation. A sub-directory fd (so /proc/916/fd, designated 303) contains links to file descriptors (files, pipes, devices and sockets) currently opened by the process. Additional detailed information about open sockets can be found in /proc/net, designated 304, in the following text files: raw, tcp, udp, unix, packet. The Kernel Info reads all needed data when the snapshot( ) method is invoked (at 305) and fills its internal data structures. It then provides all this information to the current state-module 104 through known tools, designated 30G, which allow to enumerate the data (begin( ), end( ) and to get specific info about a user (getUserInfo(UID)), a process (getProcInfo(PID)) and a file or a socket descriptor (getDescriptorInfo(PID,FD)). These tools provide the results in a structure suitable to be used by the current state module 104, as better described later.

The enumeration interface is the same used in the so-called Standard Template Library (STL), which is enclosed in all common C++ modern implementations.

In that way, the kernel info module 102 provides all the data needed for the current state module 104 to have a complete view of the initial state when the IDS is started. However, the whole operation can be invoked at any time by the current state module 104, when synchronization with the real state of the system is lost, for example because the user-space module cannot keep pace with the device driver 101. Finally, this module adds the benefit of decoupling the underlying operating system from the current state data.

The syscall processor 103 reads the system call binary data from the FIFO queue (shown in phantom lines in the bottom right portion of FIG. 1) associated with the device driver 101 and translates them into a higher level syscall abstractions. Among those considered herein, the syscall processor 103 is the last system-dependent component of the arrangement described.

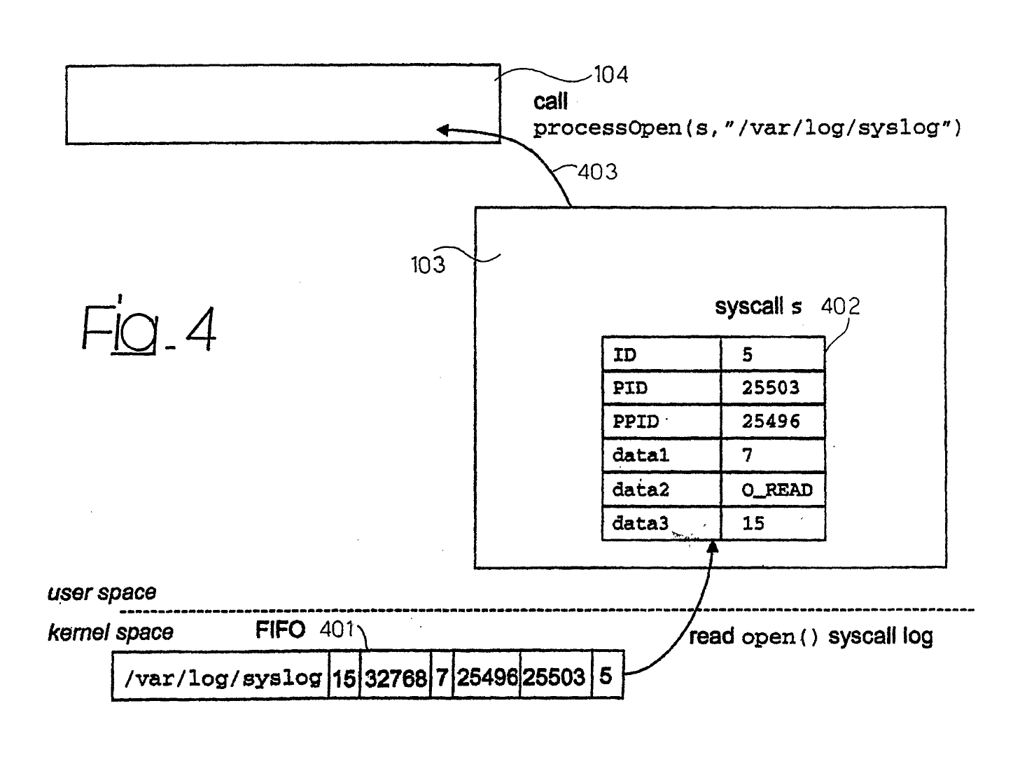

In an exemplary embodiment for a UNIX-type system, as shown in FIG. 4, the records 401 on the FIFO have a fixed size part with standard system call information: ID, PID, PPID, return value, first argument, and an extra-argument size. Then, depending on the value of the extra-argument size, some more bytes contain the extra argument of the system call. The syscall processor 103 reads all these bytes and fills a generic system-independent syscall structure 402 with PID, PPID, UID, data1 (the syscall return value), data2 (the syscall first argument), data3 (the syscall extra-argument size) values. Then it invokes the corresponding member function of the current state module 104, as shown in Table 1. If needed, the extra argument of the syscall can be found as an extra-argument of the ProcessXx( ) method, such as the name in case of a ProcessOpen( ) designated 403 in FIG. 4. In order to maintain a sufficient degree of abstraction, similar system calls are mapped onto generic one. For example, the open( ), create( ), and the pipe( ) syscalls are all mapped onto the processOpen( ).

The current state module 104 represents the instantaneous state of the monitored system; this abstraction is provided by monitoring all processes running on the system (grouped by owner of the process), and all file descriptors and socket descriptors used by each process.

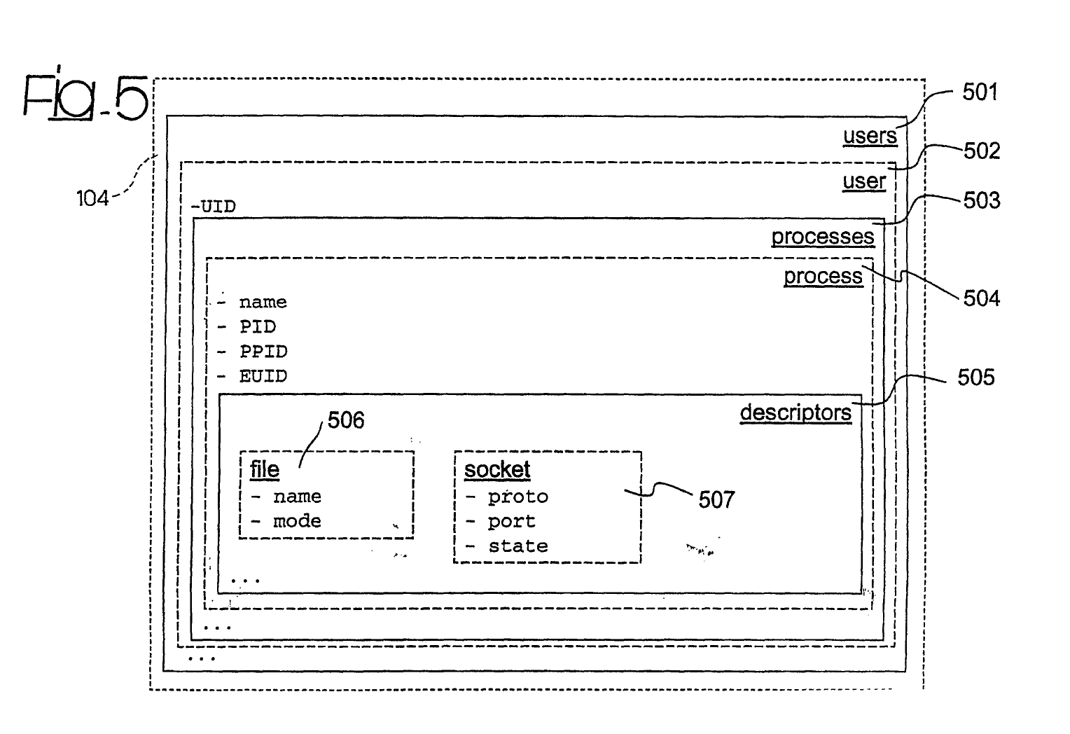

A currently preferred embodiment of such module data is, as shown in FIG. 5, a container of users 501, indexed by UID (User IDentifier), having one or more running processes. Each user record 502 contains the UID and a process container 503 grouping all the running processes for that particular user. Each record 504 of this group contains the name of the running executable file, PID, PPID, EUID and a container of descriptors 505, indexed by FID (FIle Descriptor). The descriptor is a generic abstraction for files and sockets, as it commonly happens in real UNIX-like systems. The descriptor for a file 506 is composed by the file name and the opening mode for the file (ReadOnly, WriteOnly, ReadWrite, Append). The descriptor for a socket 507 contains the protocol address information (usually IP addresses and ports) and the socket state (Created, Bound, Listening, Connected, Disconnected). During the initialization, the user container is filled with the initial system state taken from the kernel info snapshot.

Then, each system call causes a change of the internal state of the system, which is reflected in the current state module 104 using the “processXx( )” member functions. The current state module 104 provides one of these functions for each abstract system call (as shown in Table 1) and keeps track of this change by updating its internal variables so to be synchronized with the monitored system. The current state module 104 also holds a list of knowledge base module 105; the purpose of these modules is to perform a specialized analysis on a sub-component of the system. In order to do so, the current state module 104 acts as a synchronization point for all the associated knowledge base modules 105. Whenever the current state module 104 receives a syscall event or requests a re-synchronization, this event is forwarded sequentially to all the knowledge base modules 105 linked to the current state module 104. These modules can obtain further information about the system state by querying the current state module 104. The interface used to do such queries is the same used in the kernel info module 102.

The knowledge base modules 105 differs one from another for their different views of the system: some are wide and generic while others are “focused” and specialized. They monitor different aspect of the system, so they have different variables and they use different ways of counting or taking into accounts the events that occur on the system.

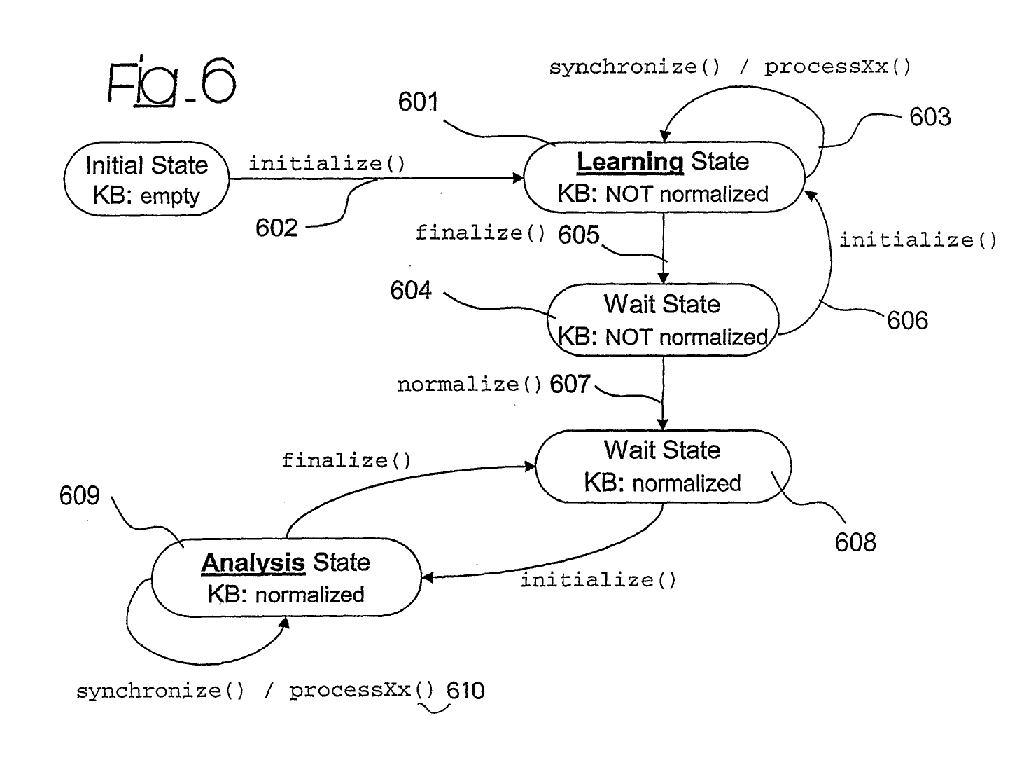

However, they all share two different modes of operation, also shown in the state diagram of FIG. 6. This diagram shows a number of stages or states typical of operation of the modules 105.

In a learning stage 601, the module fills its internal data structures (the so called “knowledge base”), by recording the initial state (with an initialize( ) function 602), all the changes caused by the syscalls (with processXx( ) functions 603), and sometimes again the instantaneous state (with a synchronize( ) function 603) in case of loss of synchronization with the current state module 104. The learning stage can be stopped (at 604) (with a finalize( ) function 605) and restarted (with an initialize( ) function 606) until the module is supposed to have collected a comprehensive view on the system behavior.

A normalization( ) function 607 operates a transaction between the two main stages. The module performs an off-line optimization of the knowledge base by pruning useless data, or translating them into a more compact form so to obtain a more efficient database and optimize the analysis stage. Therefore after normalization 608 the database is copied into a completely new one used for the analysis stage. To follow on learning the old one should be used, while a not-normalized knowledge base cannot be used in analysis stage.

In an analysis stage 609, the module uses the normalized knowledge base to analyze the state of the running system. The normalized database is now consolidated and it never changes, but it is used to match against every change caused by the system calls (with processXx( ) functions 610) or re-synchronization with the system (with a synchronize( ) function 610). Detection operates by revealing differences with the observed state. Internally, the module may use different logic mechanisms to keep track of those differences. In the current embodiment, a counting mechanism is used to track all the occurrences of certain events, such as the number of processes that a certain user is executing. Obviously, other mechanism are used accordingly the specific logic requested in the module. Whenever the module detects some differences with the recorded state, it sends to the alerter 106 a led alert, which is a structure with all possible information about the detected anomaly.

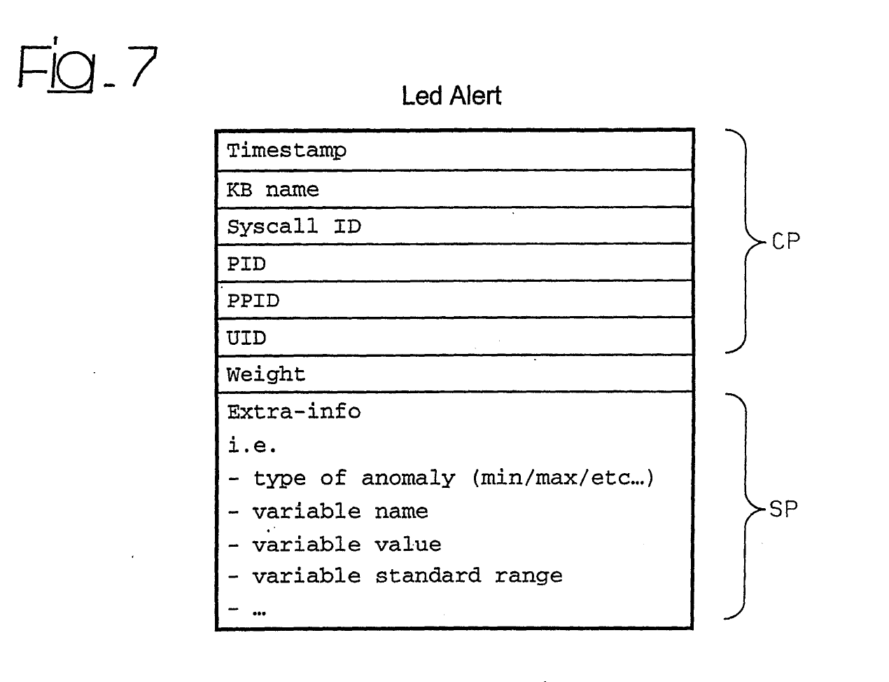

As shown in FIG. 7 the led alert has a standard part CP comprised of timestamp, module name, syscall ID, PID, PPID, UID, which is common to all knowledge base modules 105. This information is used to locate the part of the system where the anomaly happened and, for the alerter 106, to aggregate led alerts coming from different knowledge base modules 105, as will be described later in this chapter.

The remaining part SP of the led alert is knowledge base module dependent. This means that each knowledge base module 105 adds all needed information to describe in depth the anomaly.

Possible examples include, but are not limited to, the name of the variable/s that caused the anomaly, its/their current value/s and the range of values registered in the knowledge base. In addition to the current information taken from the current state module 104, every knowledge base module 105 assigns a weight to each led alert it emits, according to the “distance” of the anomaly from the regular behavior that is the state recorded during the learning phase and saved in the knowledge base. These weights will be used by the alerter 106 to correlate several led alerts and obtain a user-level alert as described in the following.

A presently preferred embodiment of the arrangement described herein uses the following knowledge base modules 105:
KBUserTable: this is a main module, designated 105a in FIG. 1, which maps accurately the information present in the current state module 104. This module gives a system wide view, without focusing on a specific aspect. The internal structure is similar to the one shown in FIG. 3 for the current state module 104. The module 105a works mainly by aggregating information such as the name of the process, or which user is executing a given process. Moreover, using specific counters, the module 105a keeps track of the number of different instances of a specific application, the number of opened files and sockets. A led alert is emitted whenever a new object, (a new user, which has never been active in the system, or a new process, that has never been observed for a specific user and so on) appears on the system. Another led alert is emitted whenever one of the counters for a specific object is exceeded (because of a creation or removal of the particular object). Of course, the module 105a does not keep track of instantaneous and time-variant data (such as PID and PPID), because they can be different for each run;
KBProcessTree: this module, designated 105b in FIG. 1, complements the previous module 105a, and takes into account the parent/child relationship, which is a common relationship among tasks in a modern operating system. The module 105b records this information in a tree-like structure. Only the process name and the relative position in the tree are recorded, and common instances of a specific process are aggregated using counters. This kind of module is able to detect whether a specific process originates any entities that have never been observed during the learning stage; this is a fairly common situation, when an intruder tries to exploit a system flaw and obtain an illegal access to the system (usually a remote shell). A led alert is emitted every time some difference in the process tree structure is observed: new child processes appear or crucial nodes (always present during the learning stage) disappear. Otherwise, a led alert with a lower weight can be raised when an application exceeds its usual number of active instances;
KBNetwork: this module, designated 105c in FIG. 1, monitors network activity; it analyzes running processes mapping their “network behavior”, that is the number and type of connection that each process uses during its life. Connections are aggregated on a per-process basis; moreover, the module 105c discriminates between “generic” connection, which are usually bound to any free port in the system, and “server” connection, which are used in a server to specify a well-known point of access to the service. The module 105c also keeps track of the traffic patterns used by specific process; that is, the number of inbound/outbound packets, the number of inbound/outbound simultaneous connection and so on. A led alert is emitted whenever a change of network behavior is observed. The list of conditions that may lead to led alert emission include: the creation of a new listening connection; the reception of an exceeding number of connection requests; the creation of a connection originating from an application that has never used the network, the reception or the transmission of an exceeding number of packets for a specific connection that has already been observed;
KBFilesystem: this module, designated 105d in FIG. 1, keeps track of all file-system related operations, on system-wide basis; particularly, it detects new mount/unmount operations, the appearance of unknown files in directory where there was no activity at all during the learning stage; the access to specific core files (such as the kernel, the device-driver modules and the security related files), the excessive creation or deletion of files in a reduced amount of time, where the exact meaning of “excessive” has been deducted during the learning stage, the excessive use of symbolic linking or the creation of links in the directory holding temporary files. In all this situations led alerts are emitted with the appropriate weight, according to the gravity of the unusual behavior. The module 105d can also combine the standard anomaly detection mechanism with few misuse detection techniques tailored to improve the overall efficiency. For example a specific security related directory or file can be set to be monitored in a deeper mode by recording more accurately all actions performed on it so to emit more precise led alerts.
KBDevices: this module, designated 105e in FIG. 1, monitors the system for device-driver or other in-kernel module related issues. The module 105e builds a list of commonly used modules, and correlates the use of specific modules with certain specific processes. For example, USB-related modules are dynamically loaded in the system when a USB device is attached to it. So some correlation is expected to exist between the loading of an USB device driver, and specific programs used to manipulate it. Whenever the system detects a module that has never been used before, or detect a module which is used in conjunction with uncommon executable files (for example, a module that spawns a remote shell as a response to a specifically crafted packet), a led alert is sent to the alerter module 106. The module 105e is fairly simple in the case of a current Unix embodiment, but can easily be extended and tailored to monitor other kernel-based components, such as the routing core system or the firewall enclosed in the kernel.

The alerter 106 processes and aggregates all the led alerts received (i.e. the anomalies detected) from the various knowledge base modules 105. Usually, single led alerts are not necessarily a sign of an intrusion, but may derive from the regular system execution, which has never been observed during the learning stage. However, if the alerter 106 receives several led alerts from independent modules, a user-lever alert is generated and sent e.g. to the management console.

The alerter 106 works essentially in two ways.

As a first task, the alerter 106 tries to aggregate different led alerts using some mathematical correlation technique.

If the sequences of led alerts loosely match a sequence of pre-conditions in the rule-base, it is possible to identify a specific behavior and issue an alert which also gives some information about what is happening on the system.

The basic correlation mechanism works on the shared field of the led alert structure. The alerter 106 uses the following logic to aggregate different led alerts.

If it receives several led alerts for the same PID (Process IDentifier), these alerts are aggregated over time according the following formula:

$$\begin{matrix}{W}_{i + 1} ( t ) = {W}_{i} ( {T}_{i + 1} - {T}_{i} ) + {LA}_{i + 1} \cdot exp ( - \frac{t - {T}_{i}}{τ} ) \\ {W}_{0} = 0\end{matrix} \qquad Eq . 1$$

where Wᵢ is the weight of the user level alert associated to the common stream of led alerts, when the i-th led alert is received; Tᵢ is the time of reception of the i-th led alert, LAᵢ is the weight associated to the i-th led alert and τ is the time-decay constant.

This formula basically means that the weight associated with each specific user-level alert is composed by the value of the weight at the previous alert emission time plus the current value modulated with an exponential decay factor; the exponential decay indicates that the importance of the alert decreases over time. The current weight value is sampled at time Tᵢ₊₁, when the alert is effectively received and, if the value is greater than a given threshold, a user-level alert for that PID is generated; the indication of the alert criticality is proportional to the weight value.

A substantially identical aggregation criterion is used for led alerts with a matching value for the UID (User IDentifier).

Several alerts with the same values in the common fields (except the timestamp) are aggregated again and only a single user-level alert is generated. The weight associated to this alert is computed again using equation 1.

The rule-based correlation mechanism uses led alerts as the input of a fuzzy logic expert system. It is possible to map the different led alerts into different fuzzy sets (one for each different led alert); using these fuzzy sets, it is possible to construct some fuzzy logic rules that indicate a specific exploitation attempt.

The following list defines some possible fuzzy sets adopted to map specific alerts:

NewApp: (KBUserTable 105a) An application that executes a new application that has never been executed before.

NewChild: (KBProcessTree 105b) an application has just forked a new child application that has never been observed.

NewListeningConnection (KBNetwork 105c): An application activates a listening network connection that has never been activated before.

NewReadFile (KBFileSystem 105d): An application opens a file (read mode) that has never been open before.

NewWriteFile (KBFileSystem 105d): An application opens a file (write mode) that has never been open before.

MaximumCountApp (KBUserTable 105a): An application exceeds its maximum number of concurrent instances.

MaximumTraffic (KBNetwork 105c): a network connection exceeds its maximum observed bandwidth.

MaximumConnectionRequest (KBNetwork 105c): a specific listening connection receives an exceeding number of connection requests.

The following list details some rules that can be used for this purpose:

Rule1: IF (NewApp and NewListeningConnection)

THEN UserAlert(‘Possible Bindshell detected’)

Rule2: IF (NewChild and NewListeningConnection)

THEN UserAlert(‘Possible Bindshell detected’)

Rule3: IF (NewWriteFile MATCHES ‘/etc/*’).

THEN UserAlert(‘Tried to write a config file′’)

Rule4: IF (NewApp and MaximumCountingApp)

THEN UserAlert(‘Possible Local Denial-of-Service or Resource Exhaustion Attempt’)

Rule5: IF (MaximumConnectionRequest and MaximumTraffic)

THEN UserAlert(‘Possible Remote Denial-of-Service Attempt’)

Of course, this rule list is not intended to be comprehensive, but has the purpose to show some of the possible attacks that this system can detect. The use of a fuzzy-logic inference engine allow the system to analyze the led alert trying to understand what is the possible cause of the led alert events detected on the system.

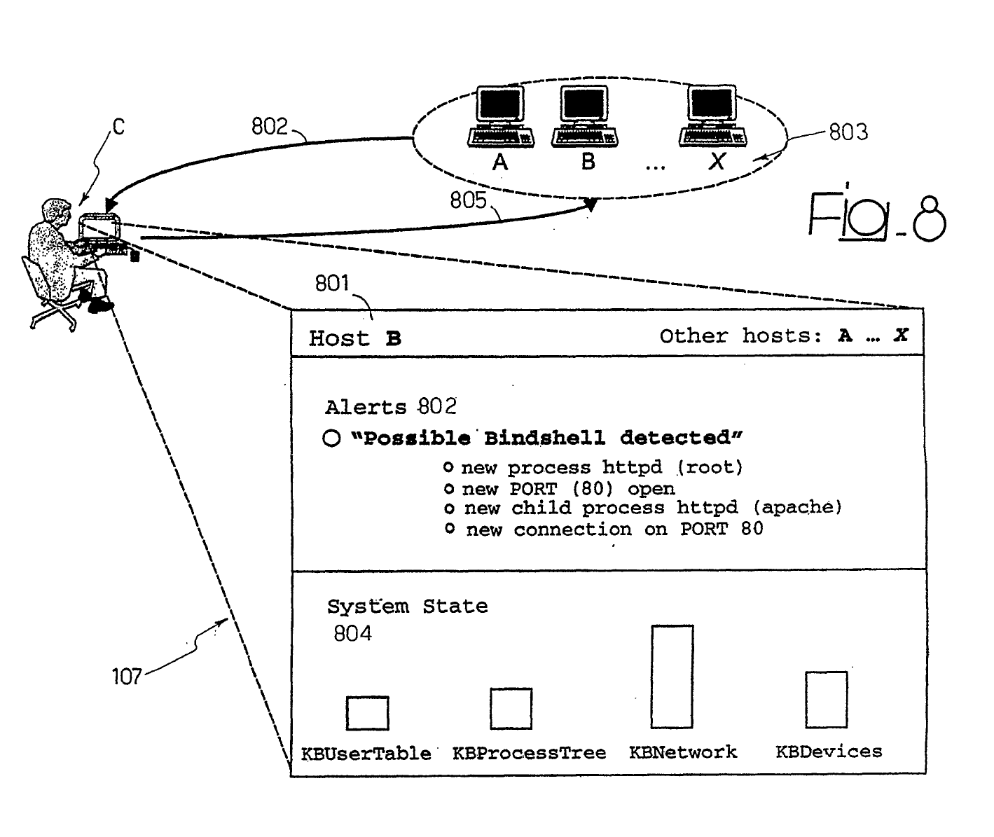

The report and logging part 107 of tie management system 103, as shown in FIG. 8, consists essentially of a graphic console C which shows on the screen 801 all the alerts 802 coming from the different monitored hosts 803. It also shows the state 804 of the monitored systems by getting information 805 about the current state of the knowledge base modules 105 in the host. It is also provided a mechanism to archive alerts on a database to perform further off-line analysis. A human operator monitors the management system 130 and can take the appropriate countermeasure to block the attacks and to enforce policies. Moreover, an administration and configuration part 108 of the management systems 130 allows to watch and to configure the behavior of every single part of the whole system.

Of course, the arrangement described in detail in the foregoing represents only one of a plurality of possible implementations of the invention.

A number of changes can be easily contemplated in alternative embodiments.

For instance the device driver 101 could be enhanced by intercepting other system calls in order to monitor parts of the system that now are not taken into account. The syscall processor 103 may therefore map this new events into existing abstraction function (see Table 1), or other new ‘ad hoc’ abstraction functions should be created.

Also, new knowledge base modules 105 can be designed and implemented, such as, e.g.:
i) a KBUserProfile module: to profile the usual behavior of users logged on a shell. This could be done by recording several information, such as the type of console (local/virtual) and connection (telnet/ssh/other), the launched processes along with time of execution and parameters of invocation. Moreover this module can support operation profiling taking into account the various behavior in different time slots (for example, the user activity is higher in business hours);
ii) a KBRegistry module to monitor e.g. Windows™ registry activity. This module would be specific for all the Windows™ Operating System that use the registry (Windows XP, 2000, NT, 98, 95). The module should record all operations (create/open/write/close/delete) made by different processes on registry keys and values.

The management system 130 can provide some form of feedback to the alerter 106, in terms of e.g. logging level and emission of alerts. Moreover, a human operator can be given the opportunity to request an update of the specific knowledge base modules 105, whenever some alerts can be tracked to regular behavior that has never been observed during the learning stage. In that way, the detection capability of the system can be updated and enhanced without having to run another learning stage.

Consequently, without prejudice to the underlying principles of the invention, the details and the embodiments may vary, also appreciably, With reference to what has been described by way of example only, without departing from the scope of the invention as defined by the annexed claims.

1-35. (canceled)

36. A method of monitoring operation of a processing system, comprising system resources and having a plurality of processes running thereon, comprising the step of monitoring, for at least two processes in said plurality, a set of system primitives that allocate or release said system resources.

37. The method of claim 36, wherein said set of primitives monitored comprises all the system primitives that allocate or release said system resources.

38. The method of claim 36, wherein said set of primitives monitored comprises exclusively those system primitives that allocate or release said system resources.

39. The method of claim 36, wherein monitoring said system primitives comprises at least one of:
tracking the processes running on said system and monitoring resources used thereby,
monitoring connections by said processes running on said system,
monitoring the file-related operations performed within said system, and
monitoring operation of commonly used modules with said system.

40. The method of claim 36, wherein said set of primitives monitored identifies a state of said processing system, the method further comprising the steps of:
recording a current state of said system over a current period of time and a previous state of the system over a previous period of time;
revealing any differences between said current state of the system and said previous state of the system; and
detecting any such difference revealed as a likely anomaly in the system.

41. The method of claim 40, wherein said anomaly detection comprises a learning stage to generate said previous state of the system based on said learning stage.

42. The method of claim 40, wherein said anomaly detection comprises the step of correlating a plurality of said anomalies detected and deciding whether these identify a dangerous event for the system.

43. The method of claim 42, comprising the step of emitting an alert signal indicative of any dangerous event for the system identified.

44. The method of claim 42, comprising the steps of:
generating a sequence of said anomalies;
producing a sequence of pre-conditions in a rule base; and
if said sequence of anomalies at least loosely matches said sequence of pre-conditions, issuing a resulting alert signal.

45. The method of claim 42, comprising the step of assigning respective weights to said anomalies in said plurality, each said weight being indicative of the criticality of the event represented by the anomaly to which the weight is assigned.

46. The method of claim 43, wherein said step of correlating comprises associating with each anomaly a value of the weight at the previous alert signal emission time plus the current value modulated with an exponential decay factor, whereby the significance thereof decreases over time.

47. The method of claim 46, wherein said processing system operates on process identifiers, whereby a plurality of anomalies are detected for the same process identifier and said anomalies are aggregated over time according to the following formula:
$$\begin{matrix}{W}_{i + 1} ( t ) = {W}_{i} ( {T}_{i + 1} - {T}_{i} ) + {LA}_{i + 1} \cdot exp ( - \frac{t - {T}_{i}}{τ} ) \\ {W}_{0} = 0\end{matrix}$$
where Wᵢ is the weight of a user level alert signal associated with the common stream of anomalies, when the i-th anomaly is detected; Tᵢ is the time of detection of the i-th anomaly, LAᵢ is the weight associated to the i-th anomaly and τ is a time-decay constant.

48. The method of claim 42, wherein said step of correlating comprises the step of mapping said anomalies in said plurality into respective fuzzy sets.

49. The method of claim 40, wherein said monitoring comprises intercepting low-level data within said system watching for changes in the state of the system, thus providing data to be analyzed in said anomaly detection.

50. The method of claim 36, comprising the step of providing a plurality of modules for performing said monitoring, said plurality of modules comprising a first set of components depending on the system being monitored and a second set of components that are independent of the system being monitored.

51. The method of claim 50, comprising the step of providing within said first set of modules at least one module selected from the group of:
a device driver for intercepting the system calls associated with said primitives in said set,
a kernel information module configured for reading information for all processes running on said monitored system, and
a system call processor configured for reading the binary data related to the system calls of said system and translating them into respective higher-level system call abstractions.

52. The method of claim 40, comprising the step of monitoring all processes running on the system monitored and all file descriptors and the socket description used by each said process to produce an instantaneous state of the system monitored.

53. An apparatus for monitoring operation of a processing system, comprising system resources and having a plurality of processes running thereon, comprising analysis modules configured for monitoring, for at least two processes in said plurality, a set of system primitives that allocate or release said system resources.

54. The apparatus of claim 53, wherein said analysis modules are configured for monitoring all the system primitives that allocate or release said system resources.

55. The apparatus of claim 53, wherein said analysis modules are configured for monitoring exclusively those system primitives that allocate or release said system resources.

56. The apparatus of claim 53, wherein said analysis modules are selected from the group of:
at least one application knowledge module tracking the processes running on said system and monitoring resources used thereby,
a network knowledge module monitoring connections by said processes running on said system,
a file-system analysis module monitoring the file-related operations performed within said system, and
a device monitoring module monitoring operation of commonly used modules with said system.

57. The apparatus of claim 53, wherein said set of primitives monitored identifies a state of said processing system, comprising a detection component configured for recording a current state of said system over a current period of time and a previous state of the system over a previous period of time, revealing any differences between said current state of the system and said previous state of the system, and detecting any such difference revealed as a likely anomaly in the system.

58. The apparatus of claim 57, wherein said detection component is configured for running a learning stage to generate said previous state of the system based on said learning stage.

59. The apparatus of claim 57, wherein said detection component is configured for correlating a plurality of said anomalies detected and deciding whether these identify a dangerous event for the system.

60. The apparatus of claim 59, wherein said detection component is configured for emitting an alert signal indicative of any dangerous event for the system identified.

61. The apparatus of claim 59, wherein said detection component is configured for:
generating a sequence of said anomalies;
producing a sequence of pre-conditions in a rule base; and
if said sequence of anomalies at least loosely matches said sequence of pre-conditions, issuing a resulting alert signal.

62. The apparatus of claim 59, wherein said detection component is configured for assigning respective weights to said anomalies in said plurality, each said weight being indicative of the criticality of the event represented by the anomaly to which the weight is assigned.

63. The apparatus of claim 60, wherein said detection component is configured for associating with each anomaly a value of the weight at the previous alert signal emission time plus the current value modulated with an exponential decay factor, whereby the significance thereof decreases over time.

64. The apparatus of claim 63, wherein said processing system operates on process identifiers (PID), whereby a plurality of anomalies are detected for the same process identifier, and said detection component is configured for aggregating said anomalies over time according to the following formula:
$$\begin{matrix}{W}_{i + 1} ( t ) = {W}_{i} ( {T}_{i + 1} - {T}_{i} ) + {LA}_{i + 1} \cdot exp ( - \frac{t - {T}_{i}}{τ} ) \\ {W}_{0} = 0\end{matrix}$$
where Wᵢ is the weight of a user level alert signal associated with the common stream of anomalies, when the i-th anomaly is detected; Tᵢ is the time of detection of the i-th anomaly, LAᵢ is the weight associated to the i-th anomaly and τ is a time-decay constant.

65. The apparatus of claim 59, wherein said detection component is configured for correlating said anomalies in said plurality by mapping them into respective fuzzy sets.

66. The apparatus of claim 57, wherein said monitoring comprises an information gathering component configured for intercepting low-level data within said system watching for changes in the state of the system, thus providing data to be analyzed in said anomaly detection.

67. The apparatus of claim 53, comprising a plurality of modules for performing said monitoring, said plurality of modules comprising a first set of components depending on the system being monitored and a second set of components that are independent of the system being monitored.

68. The apparatus of claim 67, wherein said first set of modules comprises at least one module selected from the group of:
a device driver for intercepting the system calls associated with said primitives in said set;
a kernel information module configured for reading information for all processes running on said monitored system; and
a system call processor configured for reading the binary data related to the system calls of said system and translating them into respective higher-level system call abstractions.

69. The apparatus of claim 57, comprising a current state module monitoring all processes running on the system monitored and all file descriptors and the socket description used by each said process to produce an instantaneous state of the system monitored.

70. A computer program product loadable in the memory of at least one computer and comprising software code portions for performing the steps of the method of claim 36.
